(19) United States
(12) Patent Application Publication
(10) Pub. No.: US 2008/0278727 A1
(43) Pub. Date: Nov. 13, 2008

(54) Device For Imaging an Interior of a Turbid Medium

(75) Inventors: Michael Cornelis Van Beek, Eindhoven (NL); Martinus Bernardus Van Der Mark, Eindhoven (NL); Levinus Pieter Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/093,965

(22) PCT Filed: Nov. 2, 2006
(86) PCT No.: PCT/IB06/54061

§ 371 Date: May 16, 2008

(30) Foreign Application Priority Data
Nov. 18, 2005 (EP) 05110977.5

(51) Int. Cl. G01N 21/59

(52) U.S. Cl. 356/442

(57) ABSTRACT

The invention relates to a device for imaging an interior of a turbid medium. Said device (1) comprises a measurement volume (15) for accommodating the turbid medium. Said measurement volume (15) comprises a number of sources capable of communicating light, said sources comprising a preferred source, capable of communicating preferred light and a further source, capable of communicating further light. Said device (1) further comprises a detection unit capable of detecting composed light comprising a preferred component comprising at least a part of the preferred light and a further component comprising at least a part of the further light. The device is adapted such that the negative effect said further component in the composed light may have on detecting the preferred component also present in the composed light is counteracted. According to the invention this object is realized in that the preferred source and the further source are located such that a path followed by the preferred component from the preferred source to the detector unit and a path followed by the further component from the further source to the detector unit are substantially the same.

The invention relates to a device for imaging an interior of a turbid medium, said device comprising a measurement volume for accommodating the turbid medium, said measurement volume comprising a number of sources capable of communicating light, said sources comprising a preferred source, capable of communicating preferred light and a further source, capable of communicating further light, said device further comprising a detection unit capable of detecting composed light comprising a preferred component comprising at least a part of the preferred light and a further component comprising at least a part of the further light. The term ‘light’ is understood to cover the entire electromagnetic spectrum.

The invention also relates to a medical image acquisition device comprising the device.

The invention also relates to a selection unit for coupling a light generator to the preferred source and for choosing the preferred source from the number of sources.

An embodiment of a device for imaging an interior of a turbid medium of this kind is known from U.S. Pat. No. 6,327,488 B1. The known device can be used for imaging an interior of a turbid medium, such as biological tissues. In medical diagnostics the device may be used for imaging an interior of a female breast. The measurement volume receives a turbid medium, such as a breast. The measurement volume may be bound by a holder having only one open side, with the open side being bound by an edge portion. This edge portion may be provided with an elastically deformable sealing ring. Such a holder is known from U.S. Pat. No. 6,480,281 B1. Light is applied to the turbid medium by communicating the light into the measurement volume via the preferred source, said preferred source being successively chosen from the number of sources. Light emanating from the measurement volume via further sources selected from the number of sources is detected by a detector unit and is used to derive an image of the interior of the turbid medium.

It is a drawback of the known device that the presence of the further component in the composed light hampers the detection of the preferred component that is also present in the composed light.

It is an object of the invention to counteract the effect said further component in the composed light may have on detecting the preferred component also present in the composed light. According to the invention this object is realized in that the preferred source and the further source are located such that a path followed by the preferred component from the preferred source to the detector unit and a path followed by the further component from the further source to the detector unit are substantially the same. The invention is based on the recognition that light following essentially the same path will be similarly affected by outside factors, such as attenuation. Consequently, if the intensities of light at two sources are in a certain proportion, this proportion will be maintained at the end of the paths, even if the light is attenuated. As a result of the above, paths of light should be chosen such that the proportion of intensities is maintained at the end of the paths, if the proportion of intensities is acceptable at the beginning of the paths. Analogously, paths of light should be chosen such that an acceptable proportion of intensities is obtained at the end of the paths, if the proportion of intensities is not acceptable at the beginning of the paths. Unacceptable proportions of intensities may arise if paths of light are not substantially the same, resulting in light following one path being attenuated stronger than light following another path. Consequently, the choosing of paths may involve relocating the beginnings of the original paths. An essential feature of the drawback of the known device is that at least a part of the preferred light and at least a part of the further light are detected as components of composed light. Therefore, there must be ways for at least a part of the preferred light and at least a part of the further light of arriving at the same position. In a device for imaging an interior of a turbid medium these ways include crosstalk between the paths taken by at least a part of the preferred light and by at least a part of the further light as well as the simultaneous application of light from multiple light sources to the turbid medium. With regard to the issue of crosstalk, the known device comprises a light source, a measurement volume for accommodating the turbid medium bound by a wall comprising a plurality of openings, a selection unit for coupling the light source to an opening in the wall bounding the measurement volume, said opening being successively chosen from the plurality of openings, a photodetector unit comprising multiple detector locations, and light guides for coupling the light source to the selection unit, the selection unit to openings in the wall bounding the measurement volume, and further openings in the wall bounding the measurement volume to the multiple detector locations in the photodetector unit. Light guides may be connected to each other using a connector unit comprising an entrance and an exit element for coupling a plurality of light guides simultaneously.

In locations where light guides are positioned in each other's neighborhood crosstalk can occur between light guides. In the known device these locations include the selection unit, the connector units, and the photodetector unit.

The selection unit is a potential source of crosstalk, because it couples a light guide coupled to the light source to a further light guide chosen from a plurality of further light guides coupled to openings in the wall bounding the measurement volume. As a number of the further light guides coupled to openings in the wall bounding the measurement volume are located in each other's neighborhood on the selection unit, there is the risk that at least a part of the light coming from the light source does not enter or stay in the chosen further light guide coupled to an opening in the wall bounding the measurement volume that is chosen from the plurality of further light guides, but enters another one of the further light guides that is in the neighborhood of the chosen further light guide. A connector unit is a potential source of crosstalk, because it comprises an entrance element comprising multiple light guides located in each other's neighborhood and an exit element comprising further multiple light guides, also located in each other's neighborhood, wherein light communicated by a light guide in the entrance element must be communicated to a light guide in the exit element that is located opposite the light guide in the entrance element. Analogous to the situation with the selection unit, at least a part of the light communicated by a light guide in the entrance element of a connector unit may be communicated to a light guide in the exit element of the connector unit that is not located opposite the light guide in the entrance element, but that is located in the neighborhood of the light guide in the exit element that is opposite the light guide in the entrance element.

The photodetector unit is a potential source of crosstalk, because it comprises a plurality of detector locations located in each other's neighborhood that are coupled to openings in the wall bounding the measurement volume using light guides. At least part of the light exiting a light guide that is coupled to a certain detector location may stray unto another detector location in the neighborhood of the first detector location.

As far as the detection of composed light is concerned with respect to the known device, the locations where light enters the measurement volume may be regarded as the sources of components of the composed detected light, as long as crosstalk occurs before light enters the measurement volume. In that case, there is a preferred source, communicating light directly from the light source, and at least one further source, communicating light that has undergone crosstalk. By choosing the location of the preferred source and the further source such that the paths of the preferred component and the further component that are detected as components of composed light at a single detector location are substantially the same, the presence of the further component in the composed light no longer hampers the proper detection of the preferred component. Light from the preferred source and the at least one further source will experience essentially the same attenuation by the turbid medium, thus maintaining the initial proportion of their intensities. As crosstalk usually involves only a small fraction of light, this proportion will be such that the presence of light that has undergone crosstalk at the detector location will no longer hamper proper measurement. A similar situation arises if crosstalk occurs after light has exited the measurement volume. However, in this case the location of the preferred source is the location where the light one wants to detect exits the measurement volume. The location of the further source is the location where the light, at least a part of which will experience crosstalk between the measurement volume and the detector location, exits the measurement volume. Therefore, if crosstalk occurs before light enters the measurement volume, the preferred source and a further source are the locations where light enters the measurement volume. If crosstalk occurs after light has exited the measurement volume, the preferred source and a further source are the locations where light exits the measurement volume. Although in the latter case the preferred source and a further source are not sources in the sense that light enters the measurement volume at these locations (in fact, light exits the measurement volume at these locations), they are sources in the sense that the preferred component and the further component that are detected as components of composed light at a detection unit can be regarded as parts of light originating from these locations.

With regard to the issue of simultaneously using light from multiple light sources, the known device could conceivably be adapted such that a turbid medium inside the measurement volume is not irradiated with light from a single light source, but with light from at least two light sources. In such a situation the light emitted by different light sources may have different wavelengths. As, for instance, at least a part of the light emitted by one light source and at least a part of the light emitted by another light source may exit the measurement volume through a single opening in the wall bounding the measurement volume coupled to a single detector location, the use of at least two light sources holds the risk of detecting composed light wherein a further component hampers the detection of a preferred component. If the different light sources emit light with different wavelengths, using optical filtering is not always sufficient to solve the problem. A situation is conceivable in which at least part of the light emitted by one light source is detected only after traversing the turbid medium, whereas at least a part of the light emitted by another light source is detected without the light having traversed the turbid medium, for instance because the second light source is located in the neighborhood of the opening in the wall bounding the measurement volume coupled to the detector location. In that case the intensity of the preferred component in the detected composed light may be so small, due to attenuation by the turbid medium, that, even after filtering, the intensity of a further component present in the detected composed light, including the accompanying noise, may be too large for proper detection of the preferred component. Of course, combining the preferred component and a further component in composed light may also be the result of crosstalk. As far as the detection of composed light is concerned in the case of multiple light sources, the locations where light enters the measurement volume may be regarded as the sources of components of the composed detected light. In that case, there is a preferred source, communicating light directly from one light source, and at least one further source, communicating light from another light source. By choosing the location of the preferred source and the at least one further source such that the paths of the part of the light communicated by the preferred source and the part of the light communicated by the at least one further source that are detected as components of composed light at a single detector location are essentially the same, the presence of the part of the light communicated by the at least one further source that is detected as a component of composed light at a single detector location no longer hampers the proper detection of the part of the light communicated by the preferred source that is detected as a component of composed light at that detector location.

An embodiment of the device according to the invention is characterized in that the preferred source and the further source are located such that the preferred source and the further source are adjacent. If the preferred source and the further source communicate light into the measurement volume, adjacent indicates that there are no further sources between the preferred source and the further source that communicate light into the measurement volume. If, on the other hand, the preferred source and the further source communicate light out of the measurement volume, adjacent indicates that there are no further sources between the preferred source and the further source that communicate light out of the measurement volume. This embodiment is the most rigorous implementation of the invention and has the advantage of being easy to implement. Locating the preferred source and the further source in adjacent positions maximizes the similarity between the paths taken by at least a part of the preferred light from the preferred source to the detection unit and by at least a part of the further light from the further source to the detection unit. However, as the problem solved by the invention has its origin in the detection of composed light comprising components that have been attenuated differently with a further component hampering the detection of the preferred component, the invention need not always be implemented in its most rigorous form. As the preferred source and a further source are located in increasingly similar positions, there may come a point at which the attenuation of the light communicated by the preferred source and the further source becomes such that the detection of the preferred component is no longer hampered by the presence in the composed light of a further component that stems from the further source, although at this point the preferred source and the further source need not be in adjacent positions.

A further embodiment of the device according to the invention is characterized in that the preferred light and the further light have wavelengths in the range from 400 to 1400 nanometers. This embodiment has the advantage that light with a wavelength in this range can penetrate biological tissues, such as female breasts, without some of the disadvantages of, for instance, x-rays, such as the use of ionizing radiation.

A further embodiment of the device according to the invention is characterized in that the device further comprises a selection unit for coupling a light generator to the preferred source, and for choosing said preferred source from the number of sources, said number of sources comprising subsets and said selection unit comprising an entrance element for receiving light from the light generator and an exit element comprising a number of exit locations for communicating the light from the light source to the number of sources, said exit locations comprising subsets, with the entrance and exit elements being displaceable relative to each other and with the exit locations on the exit element being arranged such that the subsets of exit locations correspond to the subsets of sources. The use of a selection unit has the advantage that radiation from a light source can be easily coupled to a preferred source communicating light into the measurement volume, said preferred source being chosen from the number of sources. However, the use of a selection unit also introduces a potential source of crosstalk. As the occurrence of crosstalk is related to the relative positioning of the exit locations on the exit element of the selection unit and as the invention concerns, among other things, the relative positioning of sources in the measurement volume with the advantage that the effect of the crosstalk on the detected composed light is reduced, the invention implies a mapping of said sources in the measurement volume to said exit locations on the exit element, with subsets of sources in the measurement volume corresponding to subsets of exit locations on the exit element. Various special arrangements present various benefits that will be discussed later.

A further embodiment of the device according to the invention is characterized in that the subsets of exit locations on the exit element of the selection unit are arranged in concentric circles. If the sources capable of communicating light into the measurement volume lie in parallel planes with the sources belonging to a single plane corresponding to a single circle, this embodiment has the advantage that it represents a ‘real’ mapping in that all exit locations on the selection unit that are geometrical neighbors correspond to neighboring sources in the measurement volume. This embodiment has the further advantage that no boundaries are required on the selection unit to prevent crosstalk.

A further embodiment of the device according to the invention is characterized in that the subsets of exit locations on the exit element of the selection unit are arranged to form consecutive segments of a single circle, with each segment corresponding to a subset of sources. This embodiment has the advantage of simplicity, a single degree of freedom along the axis of symmetry, easy assembly, and high symmetry.

A further embodiment of the device according to the invention is characterized in that the subsets of exit locations on the exit element of the selection unit are arranged in a spiral. This embodiment has the advantage that coupling a light source to a selected exit location on the spiral can be easily implemented mechanically.

A further embodiment of the device according to the invention is characterized in that the exit element of the selection unit comprises a light barrier between adjacent exit locations that correspond to non-adjacent sources. This embodiment allows greater freedom in coupling exit locations on the selection unit to sources in the measurement volume.

A further embodiment of the device according to the invention is characterized in that the exit element of the selection unit comprises a light barrier for optically separating at least two of the subsets of exit locations. One of the benefits of this embodiment is that it allows the use of an entrance element of the selection unit that is simultaneously coupled to multiple light generators. Another benefit of this embodiment is that it allows greater freedom in coupling light guides to sources in the measurement volume, because light guides that are geometrical neighbors on the selection unit, but that are separated by a barrier on the selection unit aimed at preventing crosstalk, are not optical neighbors on the selection unit and need not be coupled to sources in the measurement volume that are geometrical neighbors.

A further embodiment of the device according to the invention is characterized in that the entrance element of the selection unit comprises N entrance locations optically coupled to the light generator, said N entrance locations being arranged such that they form the corners of a first N-sided polygon and wherein the subsets of exit locations on the exit element of the selection unit are arranged such that each subset forms the corners of a second N-sided polygon with said second N-sided polygons being arranged in a grid of second N-sided polygons and with the said second N-sided polygons being congruent with the first N-sided polygon. Alternatively, overlapping grids of N-sided polygons may be used. This embodiment allows the easy use of an entrance element of the selection unit comprising N entrance locations coupled to N light sources that may be selected simultaneously. The high degree of symmetry of the grid structure offers flexibility in selecting sets of sources in the measurement volume.

According to the invention the medical image acquisition device comprises the device according to any of the previous embodiments.

According to the invention the selection unit is arranged for coupling a light generator to a preferred source and for choosing the preferred source from a number of sources, the number of sources comprising subsets and the selection unit comprising an entrance element for receiving light from the light generator and an exit element comprising a number of exit locations for communicating the light from the light source to the number of sources, the exit locations comprising subsets, with the entrance element and exit element being displaceable relative to each other and with the exit locations on the exit element being arranged such that the subsets of exit locations correspond to the subsets of sources.

These and other aspects of the invention will be further elucidated and described with reference to the drawings, in which:

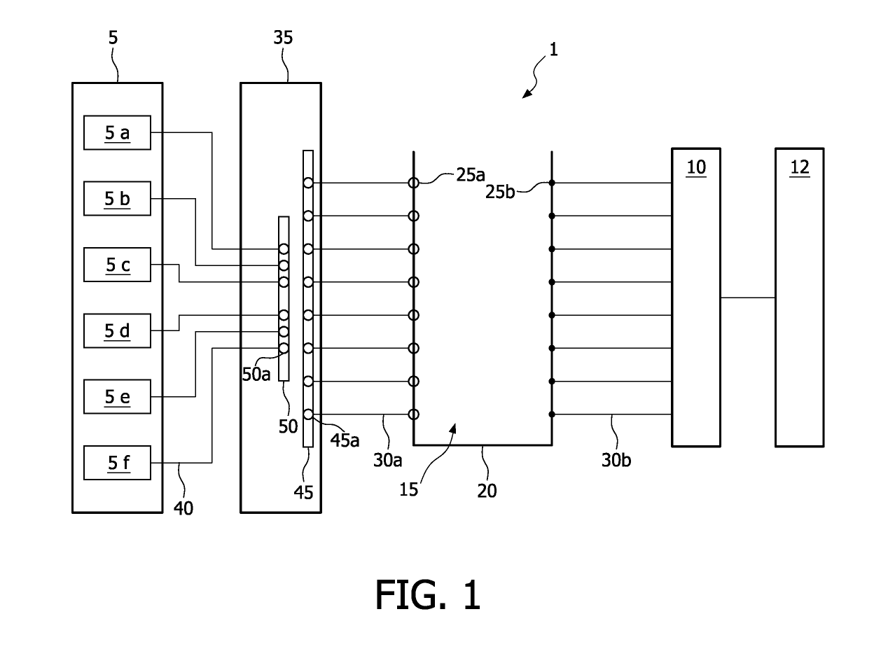

FIG. 1 schematically shows an embodiment of a device for performing measurements on a turbid medium,

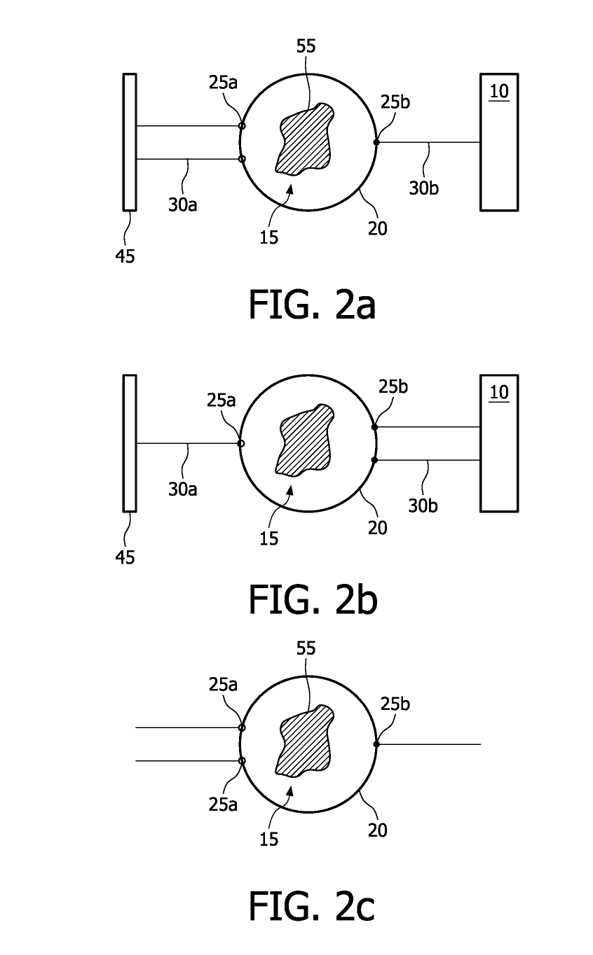

FIGS. 2a, 2b, and 2c show the positioning of a preferred source and a further source relative to each other,

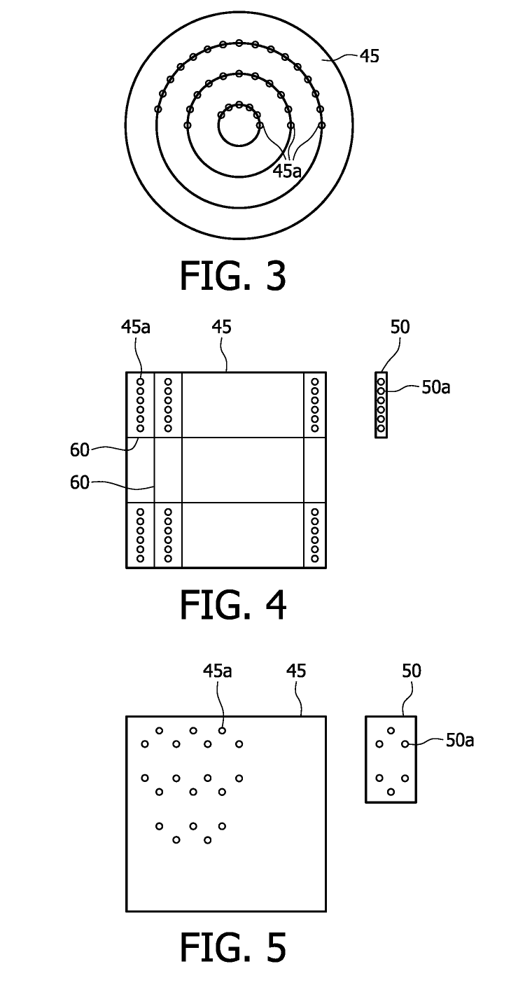

FIG. 3 illustrates possible arrangements of exit openings on an exit element of a selection unit,

FIG. 4 shows another possible arrangement of exit locations on the exit element of the selection unit in which subsets of exit locations are separated by barriers aimed at preventing crosstalk, together with the corresponding entrance element of the selection unit,

FIG. 5 shows another possible arrangement of exit locations on the exit element of the selection unit together with the corresponding entrance element of the selection unit,

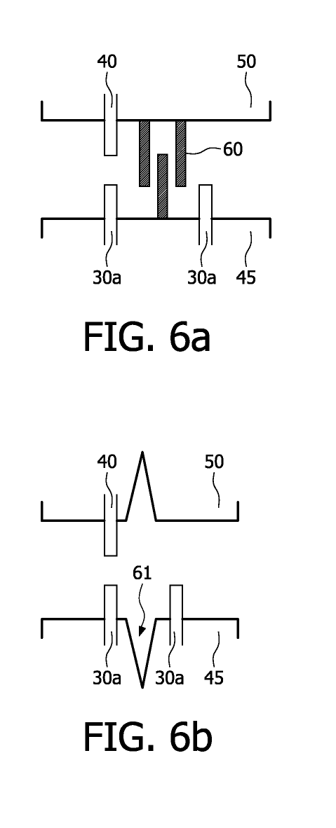

FIGS. 6a and 6b show two possible arrangements of barriers aimed at preventing crosstalk,

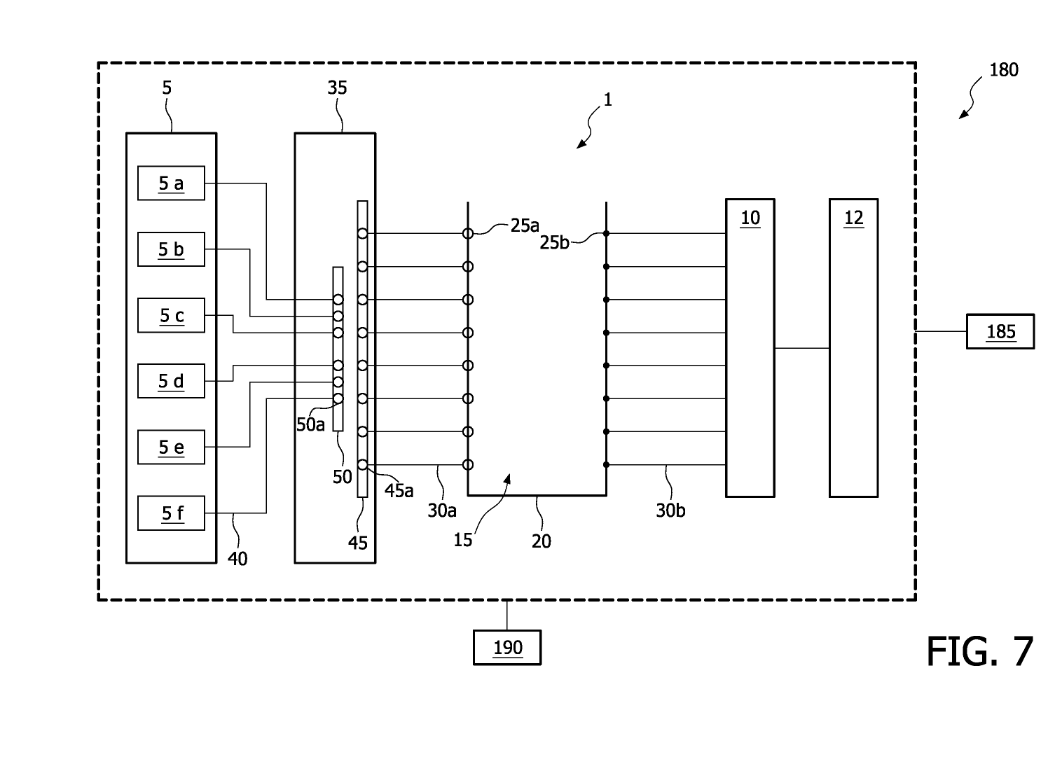

FIG. 7 shows an embodiment of a medical image acquisition device according to the invention.

FIG. 1 schematically shows an embodiment of a device for imaging an interior of a turbid medium. The device 1 includes a light source 5, which may include a number of separate sub light sources 5a, 5b, 5c, 5d, 5e, and 5f, a photodetector unit 10, an image reconstruction unit 12 for reconstructing an image of an interior of the turbid medium 55 based on light detected using the photodetector unit 10, a measurement volume 15 bound by a wall 20, said wall comprising a plurality of entrance positions for light 25a and a plurality of exit positions for light 25b, and light guides 30a and 30b coupled to said entrance and exit positions for light. The device 1 further includes a selection unit 35 for coupling the light source 5 to a number of selected entrance positions for light 25a in the wall 20. The light source 5 is coupled to the selection unit 35 using input light guides 40. The selection unit 35 comprises an exit element 45 comprising a number of exit locations 45a for communicating light from the selection unit 35 to the measurement volume 15 and an entrance element 50 comprising a number of entrance locations 50a for communicating light from the light source 5 to the exit element 45. The entrance element 50 and the exit element 45 are displaceable relative to each other. For the sake of clarity, entrance positions for light 25a and exit positions for light 25b have been positioned at opposite sides of the wall 20. In reality, however, both types of positions may be spread around the measurement volume 15. A turbid medium 55 (see FIGS. 2a, 2b, and 2c) is placed inside the measurement volume 15. The turbid medium 55 is then irradiated with light from the light source 5 from a plurality of positions by coupling the light source 5 using the selection unit 35 to successively selected entrance positions for light 25a. Light emanating from the measurement volume 15 is detected from a plurality of positions using exit positions for light 25b and using photodetector unit 10. The detected light is then used to derive an image of an interior of the turbid medium 55.

In medical diagnostics a device such as device 1 may be used for imaging the interior of biological tissues, such as a female breast. In the latter case, the device may look and work as follows. The measurement volume 15 is bound by a wall 20, which forms a cup in which a breast may be positioned. The space between the breast and the cup surface is then filled with a matching fluid, the optical properties of which closely match the optical properties of the breast or of an average breast. A large number of light guides 30a and 30b, for instance 510, is connected to the cup 20. These light guides 30a and 30b may be optical fibers. Half of the light guides, light guides 30a, are connected to a selection unit 35. The other half of the light guides, light guides 30b, are connected to a photodetector unit 10. The selection unit 35 can direct light from three different light sources, for instance light sources 5a, 5b, and 5c, which may be lasers, into any one of, for instance, 256 light guides 30a. 255 light guides 30a are coupled to the cup 20, whereas one light guide 30a is coupled directly to a detection light guide 30b. In this way, any of the, in this example, 255 light guides 30a can provide a conical light beam in the cup 20. By properly switching the selection unit 35, the light guides 30a will emit a conical light beam one after the other. The light from the selected light guide 30a is scattered and attenuated by the matching fluid and the breast, and is detected by, again in this example, 255 detectors on the photodetector unit 10. The scattering of light in breast tissue is strong, which means that only a limited amount of photons can traverse the breast compared to the reflected (or backscattered) light. Therefore, the detectors should cover a large dynamical range (about nine orders of magnitude). Photodiodes may be used as detectors. The front-end detector electronics then consists of these photodiodes and an amplifier. The gain factor of the amplifier can be switched between several values. The device 1 first measures at the lowest amplification and increases the amplification if necessary. A computer controls the detectors. This computer also controls the light sources, in these example light sources 5a, 5b, and 5c, the selection unit 35 and a pump system. All elements are mounted into a structure resembling a bed. The measurement starts with a measurement of a cup 20 filled completely with the matching fluid. This is the calibration measurement. After this calibration measurement, a breast is immersed in the fluid and the measurement procedure is carried out again. In this example, both the calibration and the breast measurement consist of 255×255 detector signals for each of the three light sources 5a, 5b, and 5c. The signals can be converted into a three-dimensional image using a process called image reconstruction. This reconstruction process, which is based on, for example, an algebraic reconstruction technique or a finite element method finds the most likely solution to the inverse problem, that is finding an image that correctly fits the measured data.

FIGS. 2a, 2b, and 2c show the positioning of a preferred source and a further source relative to each other. FIG. 2a shows a top view of a number of elements also present and described in FIG. 1. Suppose two light guides 30a are optical neighbors on the exit element 45 of selection unit 35. This means that crosstalk can occur between the light guides 30a shown in FIG. 2a. If crosstalk occurs the selected light guide 30a will communicate the majority of the light emitted by the light source 5, whereas the other light guide of the two light guides 30a shown in FIG. 2a will generally communicate only a small fraction of the light emitted by the light source 5. If the light source 5 emits light with an intensity of 1, the intensity of the light carried by the selected light guide 30a will also be essentially equal to 1. The intensity of the crosstalk light carried by the other light guide 30a will in general be orders of magnitude smaller than the intensity of the light carried by the selected light guide 30a, for instance 10⁻⁴. The positions where the light communicated by the two light guides 30a shown in FIG. 2a enters the measurement volume 15 form the positions of the preferred source and the further source. Suppose the preferred source is positioned opposite exit position for light 25b that communicates light emanating from the measurement volume 15 to the photodetector unit 10. Light from the preferred source reaching the exit position for light 25b will be strongly attenuated by passage through the turbid medium 55. Therefore, the intensity of light emanating from the preferred source and reaching the exit position for light 25b will generally be very small, such as 10⁻¹³. Should the further source be located near the exit position for light 25b, a situation not shown in FIG. 2a, the intensity of the light emanating from the further source and reaching the exit position for light 25b could be, for instance, 10⁻⁸, dwarfing the intensity of the light emanating from the preferred source and reaching the exit position for light 25b. By positioning the preferred source and the further source such that light emanating from these sources that is detected as components of composed light at a single detection location follow essentially similar paths, for which situation a possible arrangement a shown in FIG. 2a, the presence of a further component in the composed light in addition to the preferred component will no longer hamper the proper detection of the latter. If, for instance, the preferred source and the further source are positioned adjacently and opposite the exit position for light 25b, light from both sources will be similarly attenuated before reaching the exit position for light 25b. Using the figures mentioned above, the intensities of the light emitted by the preferred source and the further source and reaching the exit position for light 25b could, for instance, be equal to 10⁻¹³ and 10⁻¹⁷ respectively. The initial proportion of intensities is preserved.

FIG. 2b shows a situation that is similar to the one described in FIG. 2a. However, in this case the preferred source and the further source are positions 25b where light exits the measurement volume 15. If the preferred source is positioned such that it communicates light that has traversed the turbid medium 55 and if the further source is positioned such that it communicates light that has not traversed the turbid medium 55, a situation not shown in FIG. 2b, the intensities of the light communicated by the preferred source and the further source could be equal to, for instance, 10⁻¹³ and 10⁻⁸ respectively. Crosstalk from the light communicated by the further source to the light communicated by the preferred source could then result in light having an intensity of, for instance, 10⁻¹² being combined with light having an intensity of, in this example, 10⁻¹³. Clearly, the presence of a further component in the combined light would make proper detection of the preferred component impossible. However, if the preferred source and the further source are located in similar positions, a situation for which a possible arrangement is shown in FIG. 2b, and using the figures mentioned above, the intensities of the light reaching the preferred source and the further source are, for instance, 10⁻¹³. Should crosstalk occur before composed light is detected at detector unit 10, a small fraction of light of an intensity of, for instance, 10⁻¹⁷ originally communicated by the further source would be combined with light having an intensity of 10⁻¹³ originally communicated by the preferred source. In this case, detection of the preferred component in the combined light would not be hampered by the presence of a further component.

FIG. 2c shows the use of two light sources simultaneously. The preferred source and the further source are now formed by the positions 25a at which light from the two light sources enters the measurement volume 15. If the preferred source is positioned opposite the exit position for light 25b that communicates light to the photodetector unit 10 and if the further source is positioned near the exit position for light 25b, a situation not shown in FIG. 2c, light communicated by the further source and reaching the exit position for light 25b, having an intensity of, for instance, 1, may dwarf light communicated by the preferred source and reaching the exit position for light 25b after having traversed the turbid medium 55. The latter light may have an intensity of, for instance, 10⁻¹³. However, if the preferred source and the further source are positioned such that light communicated by these sources into the measurement volume and being detected as components of composed light at a single detection location follows substantially similar paths, as shown in FIG. 2c, the presence of a further component in the composed light will no longer hamper the proper detection of the preferred component also present in the composed light. If, for instance, light from two light sources having intensities equal to, for instance, 1 enters the measurement volume at two source positions located opposite the exit position for light 25b, the intensities of the preferred component in the further component of composed light detected at a single detection location will equal, for instance, 10⁻¹³. If the two light sources emit light with different wavelengths optical filtering can now be used to separate the preferred component and the further component in the composed light.

FIG. 3 shows an embodiment of the exit element 45 of the selection unit 35 as shown in FIG. 1. In this embodiment the subsets of exit locations 45a on the exit element 45 are arranged in concentric circles. Exit locations 45a on one circle may correspond to a subset of entrance positions for light 25a in the wall 20 bounding the measurement volume 15 that lie, for instance, on a single plane. This embodiment has the advantage that no optical boundaries are required. In a slightly different embodiment of the exit element 45 of the selection unit 35, the exit locations 45a may be arranged to form consecutive segments of a single circle with each segment corresponding to a subset of enters positions for light 25a in the wall 20 that are coupled to light guides 30a and that, for example, lie on a single plane. This slightly different embodiment has the advantage of having only one degree of freedom, of easy assembly, and of high symmetry.

FIG. 4 shows another possible embodiment of the exit element 45 of the selection unit 35. Subsets of the exit locations 45a are separated by optical barriers 60. Possible arrangements of optical barriers 60 will be a discussed in relation to FIGS. 6a and 6b. In the particular embodiment shown in FIG. 4, the subsets of the exit locations 45a comprise six linearly arranged exit locations 45a. The subsets of the exit locations 45a are congruent with the set of entrance locations 50a on the entrance element 50 of the selection unit 35, which is also shown schematically in FIG. 4. This embodiment has the advantage that multiple sub light sources 5a, 5b, 5c, 5d, 5e, and 5 f which may emit light at different wavelengths, may all be selected simultaneously and coupled simultaneously to exit locations 45a and thus to the measurement volume 15. In medical diagnostics light sources emitting light at different wavelengths may be used, as the penetration of light in tissue may depend on the wavelength of the light used. Thus, using multiple light sources emitting light with different wavelengths leads to different datasets relating to the interior of a turbid medium for each wavelength, with each dataset containing information specific of a certain wavelength range.

FIG. 5 shows another possible arrangement of the exit locations 45a on the exit element 45 of the selection unit 35. In this particular example the exit locations 45a are arranged in a grid of hexagons with the exit locations 45a forming the corners of said hexagons. The entrance locations 50a on the entrance element 50 of the selection unit 35 are arranged to form the corners of a further hexagon, said further hexagon being congruent with the hexagons formed by the exit locations 45a. The entrance locations 50a are coupled to the light source 5 comprising, in this example, six sub light sources, 5a, 5b, 5c, 5d, 5e, and 5 f that may all be selected simultaneously. As the grid of hexagons has a high degree of symmetry, with individual exit locations 45a belonging to several hexagons, it offers a high degree of freedom in selecting entrance positions for light 25a on the wall 20 bounding the measurement volume 15 for communicating light from the light source 5 to the measurement volume 15. Other arrangements in which the grid consists of N-sided polygons other than hexagons are possible as well. For such other arrangements, the arrangement of the entrance locations 50a on the entrance element 50 of the selection unit 35 is changed accordingly, with the locations 50a forming the corners of an N-sided polygon that is congruent with the N-sided polygons forming the grid of N-sided polygons.

FIGS. 6a and 6b show two possible arrangements of optical barriers. Depicted in FIGS. 6a and 6b is the entrance element 50 of the selection unit 35. Coupled to said entrance element 50 is a light guide 40 coupled to the light source 5 (light source not in FIGS. 6a and 6b). Also depicted in FIG. 6a and FIG. 6b is the exit element 45 of the selection unit 35. Coupled to said exit element 45 are two light guides 30a coupled to the wall 20 bounding the measurement volume 15. In FIG. 6a mechanical optical barriers 60 are present allowing movement of the entrance element 50 and the exit element 45 relative to each other in a direction perpendicular to the plane of the drawing only. The mechanical optical barriers 60 work by physically blocking light that might stray from the light guide 40 into the unselected light guide 30a instead of going from the light guide 40 to the selected light guide 30a. In FIG. 6b an optical barrier 61 is present allowing relative motion of the entrance element 50 and the exit element 45 both in a direction perpendicular to the plane of the drawing and in a direction parallel with the plane of the drawing. The optical barrier 61 has the shape of a notch and works by trapping light that might stray from the light guide 40 into the unselected light guide 30a in a number of reflections in the notch.

FIG. 7 shows embodiment of a medical image acquisition device according to the invention. The medical image acquisition device 180 comprises the device 1 discussed in FIG. 1 as indicated by the dashed square. In addition to the device 1 the medical image acquisition device 180 further comprises a screen 185 for displaying an image of an interior of the turbid medium 45 and an input interface 190, for instance, a keyboard enabling and operated to interact with the medical image acquisition device 180.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the system claims enumerating several means, several of these means can be embodied by one and the same item of computer readable software or hardware. The mere fact that certain measures are recited in mutually different dependent claims does not indicate that a combination of these measures cannot be used to advantage.

1. A device (1) for imaging an interior of a turbid medium (55), the device (1) comprising a measurement volume (15) for accommodating the turbid medium (55), the measurement volume (15) comprising a number of sources capable of communicating light, the sources comprising a preferred source, capable of communicating a preferred light and a further source, capable of communicating further light, the device (1) further comprising a detection unit capable of detecting composed light comprising a preferred component comprising at least a part of the preferred light and a further component comprising at least a part of the further light characterized in that
the preferred source and the further source are located such that a path followed by the preferred component from the preferred source to the detection unit and a path followed by the further component from the further source to the detection unit are substantially the same.

2. A device (1) as claimed in claim 1, wherein the preferred source and the further source are located such that the preferred source and the further source are adjacent.

3. A device (1) as claimed in claim 1, wherein the preferred light and the further light have wavelengths in the range from 400 to 1400 nanometers.

4. A device (1) as claimed in claim 1, wherein the device (1) further comprises a selection unit (35) for coupling a light generator (5) to the preferred source, and for choosing the preferred source from the number of sources, the number of sources comprising subsets and the selection unit (35) comprising an entrance element (50) for receiving light from the light generator (5) and an exit element (45) comprising a number of exit locations (45a) for communicating the light from the light source to the number of sources, the exit locations (45a) comprising subsets, with the entrance element (50) and exit element (45) being displaceable relative to each other and with the exit locations (45a) on the exit element (45) being arranged such that the subsets of exit locations (45a) correspond to the subsets of sources.

5. A device (1) as claimed in claim 4, wherein the subsets of exit locations (45a) on the exit element (45) of the selection unit (35) are arranged in concentric circles.

6. A device (1) as claimed in claim 4, wherein the subsets of exit locations (45a) on the exit element (45) of the selection unit (35) are arranged to form consecutive segments of a single circle, with each segment corresponding to a subset of sources.

7. A device (1) as claimed in claim 4, wherein the subsets of exit locations (45a) on the exit element (45) of the selection unit (35) are arranged in a spiral.

8. A device (1) as claimed in claim 4, wherein the exit element (45) of the selection unit (35) comprises a light barrier (60) between adjacent exit locations (45a) that correspond to non-adjacent sources.

9. A device (1) as claimed in claim 4, wherein the exit element (45) of the selection unit (35) comprises a light barrier (60) for optically separating at least two of the subsets of exit locations (45a).

10. A device (1) as claimed in claim 4, wherein the entrance element (50) of the selection unit (35) comprises N entrance locations (50a) optically coupled to the light generator (5), the N entrance locations (50a) being arranged such that they form the corners of a first N-sided polygon and wherein the subsets of exit locations (45a) on the exit element (45) of the selection unit (35) are arranged such that each subset forms the corners of a second N-sided polygon with the second N-sided polygons being arranged in a grid of second N-sided polygons and with the second N-sided polygons being congruent with the first N-sided polygon.

11. A medical image acquisition device comprising the device (1) according to claim 1.

12. A selection unit (35) for coupling a light generator (5) to a preferred source, and for choosing the preferred source from a number of sources, the number of sources comprising subsets and the selection unit (35) comprising an entrance element (50) for receiving light from the light generator (5) and an exit element (45) comprising a number of exit locations (45a) for communicating the light from the light source to the number of sources, the exit locations (45a) comprising subsets, with the entrance element (50) and exit element (45) being displaceable relative to each other and with the exit locations (45a) on the exit element (45) being arranged such that the subsets of exit locations (45a) correspond to the subsets of sources.
